(19) United States
(12) Patent Application Publication
(10) Pub. No.: US 2012/0054041 A1
(43) Pub. Date: Mar. 1, 2012

(54) SHOPPING PROFILE IN AN ONLINE SHOPPING ENVIRONMENT

(75) Inventor: Diana Williams, Burlingame, CA (US)

(73) Assignee: eBay Inc., San Jose, CA (US)

(21) Appl. No.: 13/011,374

(22) Filed: Jan. 21, 2011

Related U.S. Application Data
(60) Provisional application No. 61/377,916, filed on Aug. 28, 2010.

(51) Int. Cl. G06Q 30/00

(52) U.S. Cl. 705/14.66; 705/27.1

(57) ABSTRACT

A method and system for creating shopping profiles is provided. The shopping profile includes selected shopping parameters of a user such as size and favorite brands, among others. The system stores a user's shopping profile for a first type of item, and renders the shopping profile to the user at a subsequent log-in of the user. If the user accesses the page of a second type of item, a shopping profile for the second type of item, including the stored selected shopping parameters of the shopping profile for the first type of item, is automatically rendered for the user. A user can also create a plurality of shopping profiles for shopping for different classes of items, for example high priced items and low priced items, with the selected shopping parameters of the first class of items automatically rendered in the shopping profile for the second class of item when it is created. The user's shopping profiles can be rendered for the user at subsequent logins, and the user can choose the desired shopping profile from which she wishes to shop, without having to re-refine the shopping profiles at each log-in. The user can create shopping profiles for other users. The selected shopping parameters of a plurality of users of the system can be mined and used for inventory management.

### RELATED APPLICATIONS

This application is related to and claims priority to provisional patent application Ser. No. 61/377,916 entitled “Shopping Profile in an Online Shopping Environment,” which was filed on Aug. 28, 2010, which is assigned to the assignee of this application, and which is hereby incorporated herein by reference in its entirety.

### TECHNICAL FIELD

The present disclosure generally relates to data processing techniques. More specifically, the present disclosure relates to methods and systems for displaying item listings to a user interface.

### BACKGROUND

Advancements in computer and networking technologies have enabled persons to conduct commercial and financial transactions “on-line” via computer-based applications. This has given rise to a new era of electronic commerce (often referred to as e-commerce.) A number of well-known retailers have expanded their presence and reach by operating websites that facilitate e-commerce. In addition, many new retailers, which operate exclusively online, have come into existence. The business models utilized by enterprises operating online are almost as varied as the products and services offered. For instance, some products and services are offered at fixed prices, while others are offered via various transaction methods, and still others are offered via a system of classified ad listings. Some enterprises specialize in the selling of a specific category of product (e.g., books) or a specific service e.g., tax preparation), while others provide a myriad of categories of items and services from which to choose. Some enterprises serve only as an intermediary, connecting sellers and buyers, while others sell directly to consumers.

### DESCRIPTION OF THE DRAWINGS

Some embodiments are illustrated by way of example and not limitation in the figures of the accompanying drawings, in which:

FIG. 1 is a block diagram of a network environment including a network-connected client system and server system, with which an embodiment of the invention might be implemented.

FIG. 1A is an illustration of a system, including an analysis module, within the server system of FIG. 1.

FIG. 2 illustrates is a database diagram illustrating an example of a database for the transaction facility.

FIG. 3 illustrates an example of a fashion related page on an e-commerce system website.

FIG. 4 illustrates an example of a women's clothing page on an e-Commerce system web site.

FIG. 4A illustrates a navigation pane that can be used as illustrated in FIG. 4.

FIG. 5 illustrates an example of operation of a sliding silhouette that uncovers multiple silhouettes for item selection.

FIG. 5A is a navigation pane that can be used as illustrated in FIG. 5.

FIG. 5B is an example of an implementation of the operation of FIG. 5.

FIGS. 5C and 5D illustrate an example of an implementation of the operation of creating shopping profiles.

FIG. 6 illustrates an example of a layer that can open when a button that asks for additional brands is clicked, the brands then being viewable and selectable.

FIG. 7 illustrates an example of a picture of a product of a given brand, using image similarity to match the product with similar products of different brands.

FIG. 8 illustrates a window for creating shopping profiles for later use.

FIG. 9 illustrates a diagrammatic representation of machine in the example of a form of a computer system.

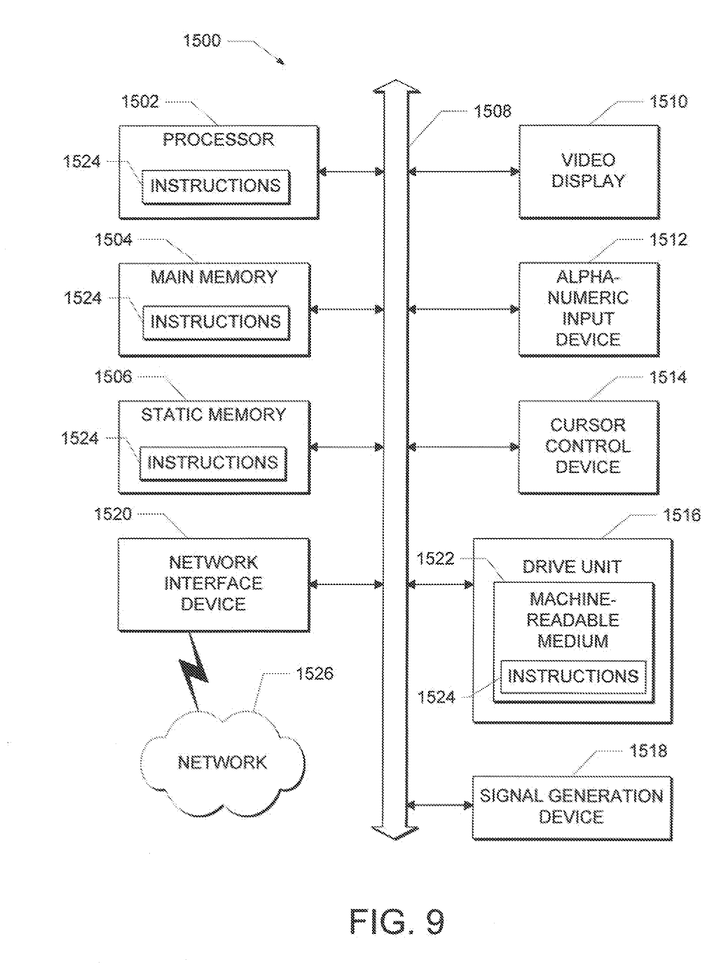

### DETAILED DESCRIPTION

Methods and systems are described for using a shopping profile of a user to query a repository of item listings in the context of an on-line trading platform. Despite the many technical advances that have improved the state of e-commerce, a great number of technical challenges and problems remain. One such problem involves determining how to best present products and services (e.g., items) that are being offered for sale, so as to maximize the likelihood that a transaction (e.g., the sale of a product or service) will occur. For instance, when a potential buyer performs a search for a product or service, it may often be the case that the number of item listings that satisfy the potential buyer's query far exceeds the number of item listings that can practically be presented on a search results page. Furthermore, when a potential buyer selects from a user interface an item of interest by textual name of that item, a selection error can occur. That is, the potential buyer might select the incorrect name of the product, such as selecting a clutch handbag when an evening handbag is really desired. Preventing that error and providing the potential buyer with an image of the precise type of item he or she is looking for enhances the shopping experience and is more likely to lead to an executed transaction.

in the following description, for purposes of explanation, numerous specific details are set forth in order to provide a thorough understanding of the various aspects of different embodiments of the present invention. It will be evident, however, to one skilled in the art, that the present invention may be practiced without these specific details.

### TERMINOLOGY

For the purposes of the present specification, the term “transaction” shah be taken to include any communications between two or more entities and shall be construed to include, but not be limited to, commercial transactions including sale and purchase transactions, auctions and the like.

### Transaction Facility

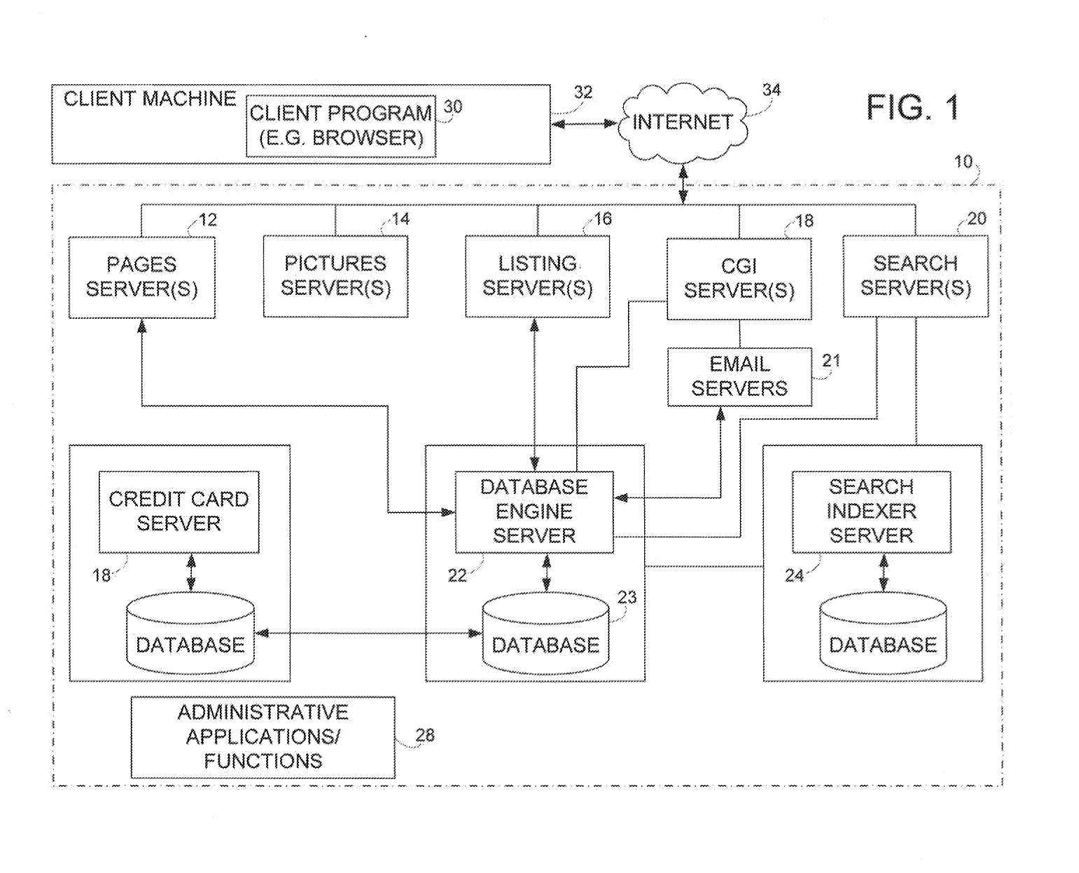

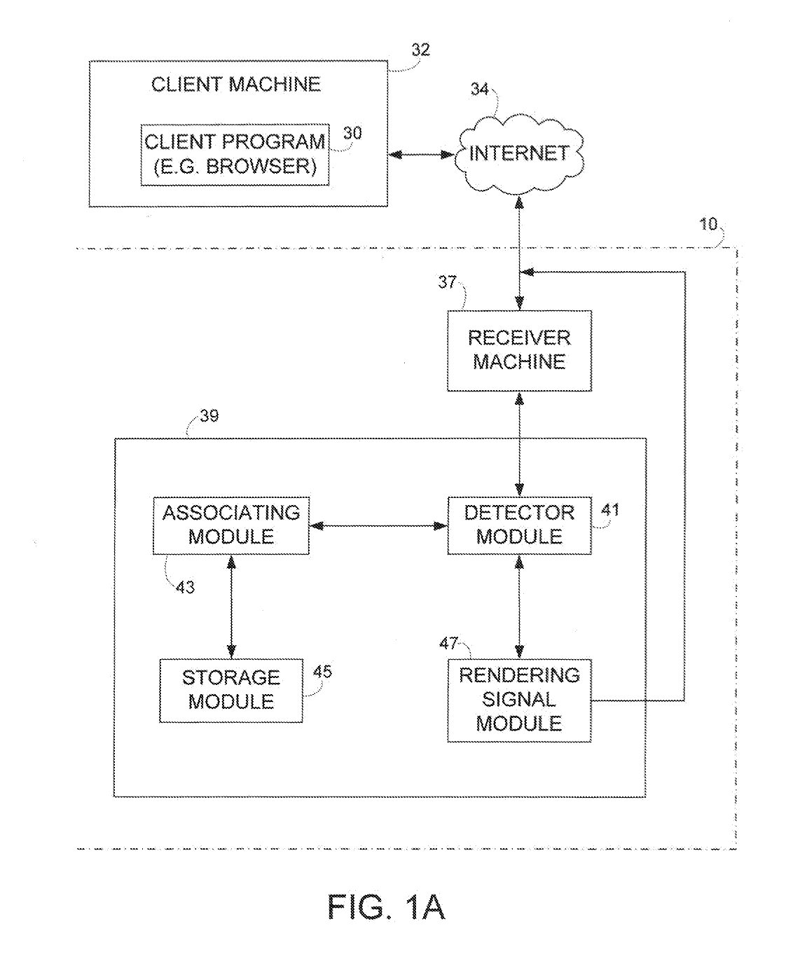

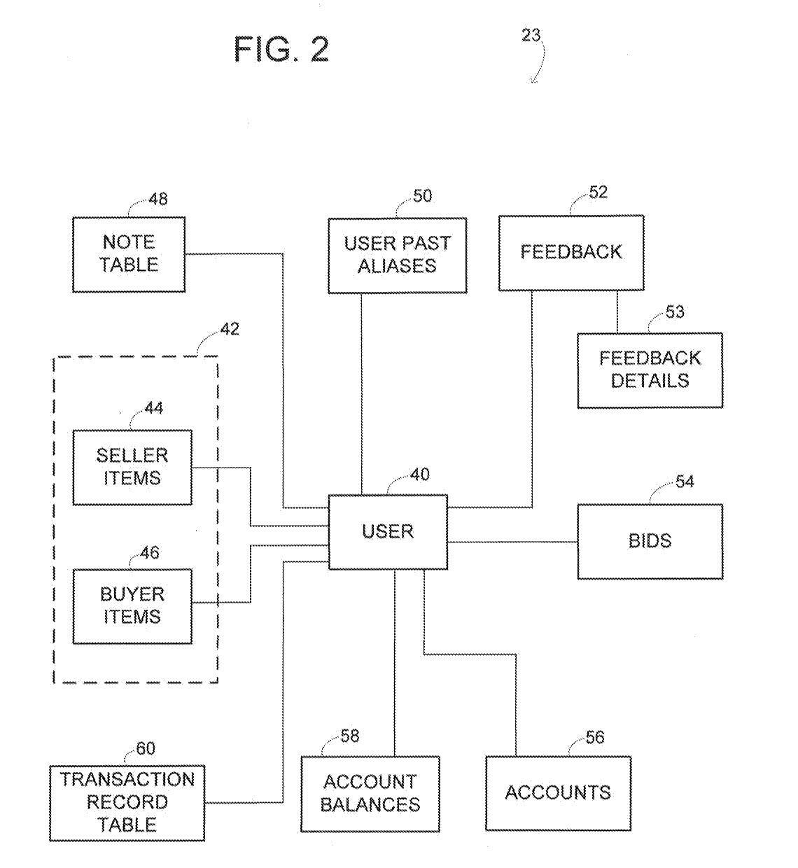

To better understand the invention, an embodiment of an electronic transaction facility is shown in FIGS. 1, 1A, and 2.

FIG. 1 is a block diagram illustrating an example of a network-based transaction facility in the form of an Internet-based transaction facility 10. While an example of an embodiment of the present invention is described within the context of an transaction facility, it will be appreciated by those skilled in the art that the invention will find application in many different types of computer-based, and network-based, commerce facilities. It will also be appreciated by those skilled in the art that the invention may be used in transaction facilities of other architectures. The instructions stored in the transaction facility (which can be executed by a processor) can be stored on a machine-readable medium including, but not limited to read only memory (ROM), random access memory (RAM), magnetic disk storage media, optical storage media, flash memory devices, or electrical, optical, acoustical or other form of propagated signals.

The transaction facility 10 within which an embodiment can be implemented includes one or more of a number of types of front-end servers, namely page servers 12 that deliver web pages (e.g., markup language documents), picture servers 14 that dynamically deliver images to be displayed within Web pages, listing servers 16, CGI servers 18 that provide an intelligent interface to the back-end of transaction facility 10, and search servers 20 that handle search requests to the transaction facility 10. E-mail servers 21 provide, inter alia, automated e-mail communications to users of the transaction facility 10.

The back-end servers include a database engine server 22, a search index server 24 and a credit card database server 26, each of which maintains and facilitates access to a respective database.

The Internet-based transaction facility 10 may be accessed by a client program 30, such as a browser (e.g., the Internet Explorer distributed by Microsoft Corp. of Redmond Wash.) that executes on a client machine 32 and accesses the transaction facility 10 via a network such as, for example, the Internet 34. Other examples of networks that a client may utilize to access the transaction facility 10 include a wide area network (WAN), a local area network (LAN), a wireless network (e.g. a cellular network), or the Plain Old Telephone Service (POTS) (or PSTN) network.

Turning to FIG. 1A, there is seen a system that forms part of the transaction facility 10 of FIG. 1. The transaction facility 10 is shown in part in the drawing to make it clear that the system forms only a part of the facility. The system includes a receiver module 37 for receiving signals from client machine 32. Also included is analysis module 39. Analysis module 39 includes detector module 41 for detecting the creation by a user at client machine 31 of at least one shopping profile. The detector module may also detect queries and/or log-in's by users. The analysis module 39 also includes an associating module 43 responsive to the detection of the creation of the shopping profile(s) for associating the shopping profile(s) with a user. The user may be the user who created the profile, or it may be a user named by the user who created the profile. Coupled to the associating module 43 is a storage module 45 for storing the shopping modules. The storage module 45 could also be used for retrieving shopping profiles from storage. The shopping profile(s) in one embodiment are stored as associated with the user. The shopping profiles can be stored in an appropriate database (not shown in FIG. 1A) at the transaction facility 10. A rendering signal module 47 is coupled to the detector module and can be responsive to signals from the from the receiver module, for example detected by detector module 41, for providing a signal for rendering one or more of the shopping profiles for the user at the client machine.

### Database Structure

FIG. 2 is a database diagram illustrating an example of a database 23, maintained by and accessed via the database engine server 22, which at least partially implements and supports the transaction facility 10. The database 23 may, in one embodiment, be implemented as a relational database, and includes a number of tables having entries, or records, that are linked by indices and keys. In an alternative embodiment, the database 23 may be implemented as a collection of blocks in a block-oriented database. While FIG. 2 shows one embodiment of a database, it will be appreciated by those skilled in the art that the invention can be used with other database structures.

Central to the database 23 is a user table 40, which contains a record for each user of the transaction facility 10. A user may operate as a seller, buyer, or both, within transaction facility 10. The database 23 also includes item tables 42 that may be linked to the user table 40. Specifically, the item tables 42 include a seller items table 44 and a buyer items table 46. A user record in the user table 40 may be linked to multiple items that are being, or have been auctioned or otherwise marketed via the transaction facility 10. A link indicates whether the user is a seller or a buyer with respect to items for which records exist within the items tables 42. While offerings by the seller are referred to as “items” in the specification, “items” includes any product or service offered by the seller. The database 23 also includes a note table 48 populated with note records that may be linked to one or more item records within the item tables 42 and/or to one or more user records within the user table 40. Each note record within the note table 48 may include, inter alia, a comment, description, history or other information pertaining to an item being auctioned or otherwise sold via the transaction facility 10 or to a user of the transaction facility 10.

A number of other tables are also shown to be linked to the user table 40, namely a user past aliases table 50, a feedback table 52, a bids table 54, an accounts table 56, and an account balances table 58.

The on-line trading system includes a user interface which may be provided to a user via the browser 30 that permits a user to submit a query including one or more search terms that describe an item the user is interested in seeing for possible purchase. Usually a user would like to browse a category of images, for example hand bags, that may be grouped by style and/or brand so that the user can quickly find an item of interest. As the user selects one or more of the category choices for the desired item, the on-line trading system accesses and presents to the user images of items from the one or more selected categories. For instance, a number of product types can be presented via the user interface by the name of a product type, such as shoes, handbags, clothes, and the like. If the user desires to search for a handbag, the category selections presented to the user in textual form by the user interface might be the words “clutch,” “evening bag,” “messenger style,” and “satchel,” among others. It could occur that the user might confuse, as one example, “clutch” with “evening bag” and enter “clutch” as the selected category, when the user is actually looking for an evening bag. This would result in one or more images of a dutch being presented to the user, when the user actually wanted one or more images of an evening bag to be returned. Thus the item image being returned to the user that is not from the actual category of items that the user desires, and the user's experience may be therefore less than optimum. This in itself may result in the transaction not being executed.

In one embodiment, the selection categories may be presented to the user in visual form, such as, e.g., a silhouette of the product. The user will see an image of the category of handbag and images of “clutch,’ “evening bag,” “messenger style,” and “satchel, which may contribute to reducing of the number of inadvertently erroneous selections. This could be, for example, presented by brand. The user could then, as only one example of an embodiment, mouseover each image to display the name of each of the various types of handbag offered for each image. Mouseover is a well known function and an example, taken from Wikipedia, is seen in the appendix to this specification. The user could then click on an image of the bag of the user's choice to view possible attributes of the bag such as styling, color and fabric, among others. This can be implemented, in one embodiment, by utilizing images of types of handbags being presented to the user in silhouette so that the users could, for example, mouseover the silhouette image that resemble most the category of bag desired and the title of the bag would be presented. For example, the user interface can present the prospective buyer with silhouettes of a clutch, an evening bag, a messenger style bag, and a satchel, among others. Seeing the silhouette images, the buyer can mouseover them for the name and simply select the silhouette of the category of bag desired, for example an evening bag, and the system displays the images of types of evening bags offered for sale. One of ordinary skill in the art will see that the displaying the title is not necessary for the invention. The user might just select the silhouette based on recognizing the silhouette. In this manner in which a buyer can find products or services which they wish to purchase.

In response to the selection of a product category, information, including images and attributes of the selected silhouette can then be presented to the user via the user interface. In one embodiment, this is accomplished by the system mapping the selected evening bag image information of this example to a textual value and making a query to the transaction facility 10 which will undertake a search using the query and will then obtain and return the foregoing image and attributes. In another embodiment, attributes of the images can be returned separately for presentation to the user by way of the user interface. The presentation of a silhouette corresponding to a category of product to the user may contribute to enhancing user experience as it may reduce the opportunity for error.

As another example, if a user is interested in women's shoes, various type of women's shoes, such as high heels, pumps, flats, sandals, and the like, may be presented in silhouette. The user may mouse over the silhouettes to display the name of the associated category, as only one example, and click to select the category of shoe of interest from the silhouettes, for example, high heels. One or more images of high heel shoes of various types and attributes can be returned for presentation to the user for possible purchase, much the same way images of handbags were returned in the above example. The various types of heels could be three-inch heels stilettos. Cuban heels, and the like. Attributes could be fabric, color, size, price and availability, among others.

In some embodiments, a user operates a web browser application 30 on a client machine 32 to interact with the transaction facility 10. A user may be presented with a search interface on client browser 30, with items in silhouette, as described generally above, and in more detail below, from which the user can select an item to be used in generating a search request submitted to the transaction facility. In some embodiments users themselves may be able to select certain item attributes. For example, the user may be interested in women's shoes. Certain type of women's shoes is provided to the user interface in visual representation as silhouettes. The user selects a category of shoe in silhouette, and, as a result, images of shoes of that category, with certain attributes, such as the color, fabric, size, price, and the like, will be returned for the user to see and possibly purchase. This can be implemented by the transaction facility 10, after receiving and processing the search request, communicating a response to the web browser application 30. The response could be, for example, an Internet document or web page that, when rendered by the browser application 30, displays a search results page showing one or more item listings, possibly with attributes, that satisfy the user's search request. The item listings are, in some embodiments, may be presented in silhouette by a presentation module, which may be a web server or an application server.

In some embodiments, the search engine module, not shown but of a type well known in the industry, could provide the actual search function. For instance, the search engine module, in some embodiments, receives and processes a search request to identify the item listings that satisfy the search request. It will be appreciated by those skilled in the an that a variety of search techniques might be implemented to identify item listings that satisfy a search request. In general, however, the item attributes of item listings are analyzed for the presence of the user-provided search terms. For instance, in some embodiments, selected silhouette can be converted to textual information and used to query system storage.

In an alternative embodiment, the search engine module may represent an interface to a search engine implemented as an external component or module, for example, as part of transaction facility 10, or as a separate external module. In such a scenario, the search engine module may simply receive the set of item listings that satisfy a search query.

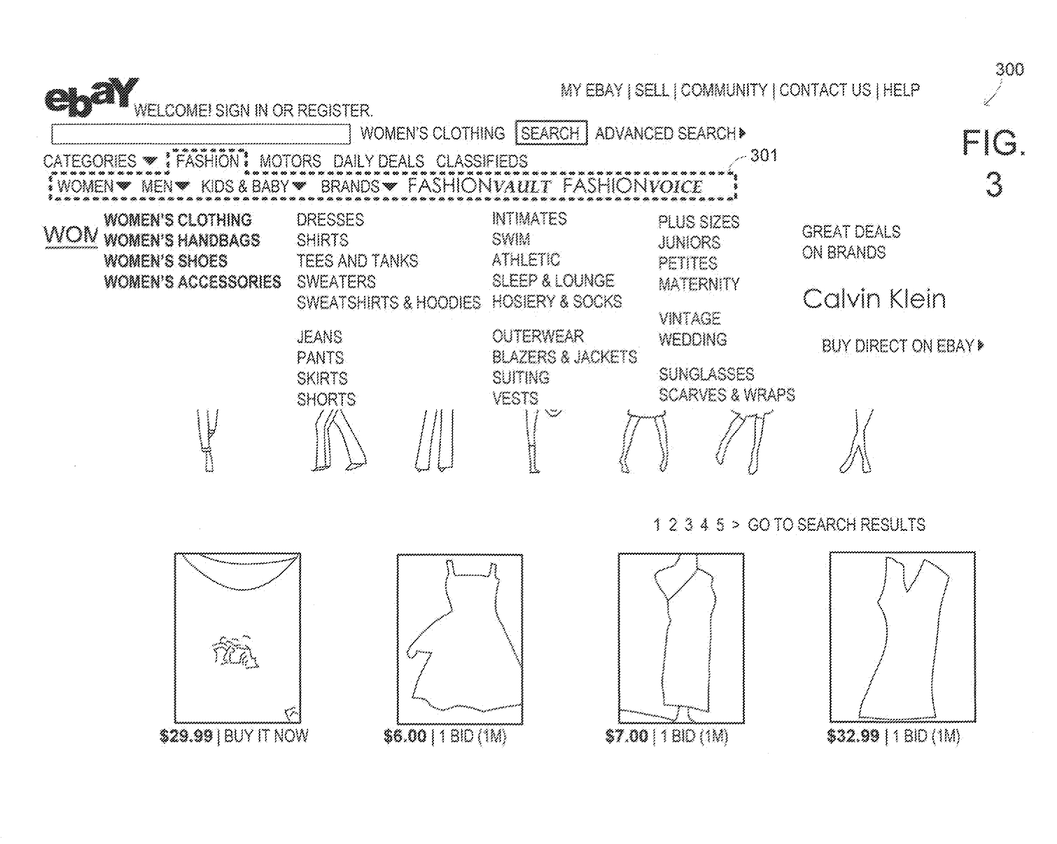

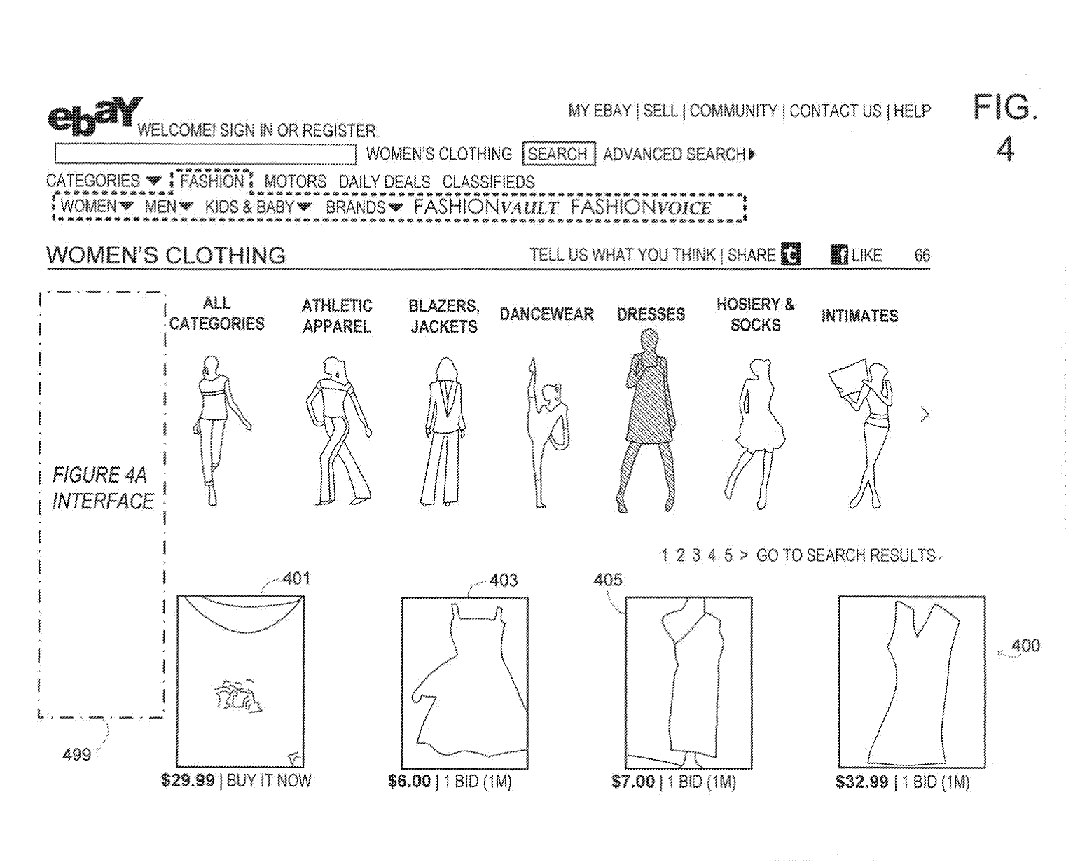

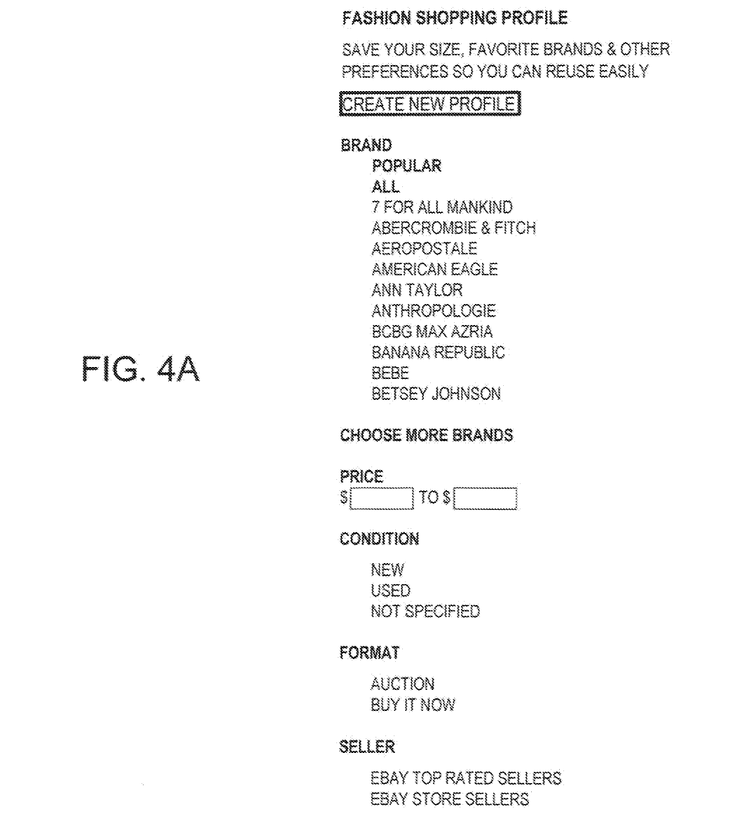

FIG. 3 illustrates a fashion related web page 300 having a bar 301 with various categories such as women's clothing, men's clothing, and the like. If the user positions the cursor over any an item certain fly-out navigation appears. For example, hovering over text “Women” will result in the categories of women's items being presented on the page 300. Hovering over or clicking on text “Women's Clothing,” for example, results in presenting of the Women's Clothing page shown in FIG. 4. Shown in the illustration of FIG. 4 is All Categories and the results set 400 with items 401, 403, 405, and the like. As can be seen, and as discussed above, the landing page of FIG. 4 that is presented to the user upon selecting “Women's Clothing” of FIG. 3, embodies silhouettes for much of its graphics. “Women's Clothing” text shown in FIG. 3 is given as an example, it being understood that what is described could be applied to “Men's Clothes” text, “Women's Shoes” text, “Men's Shoes” text, and any of the other categories listed in FIG. 3 representing categories of items being offered for sale.

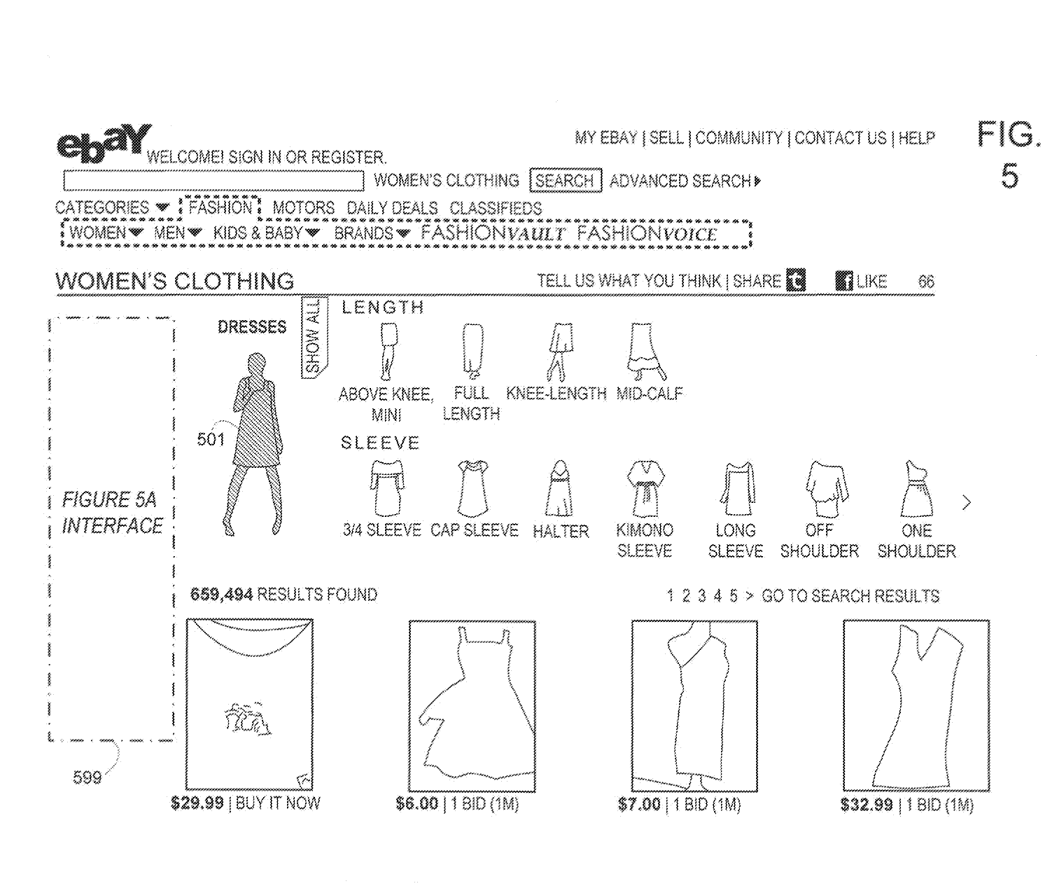

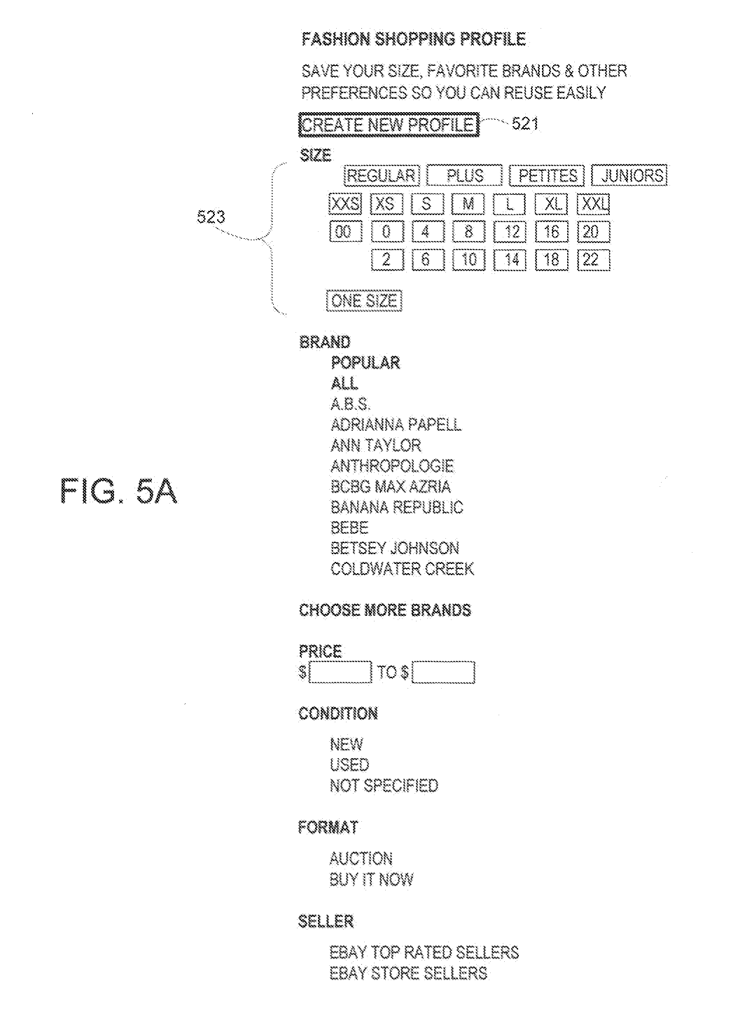

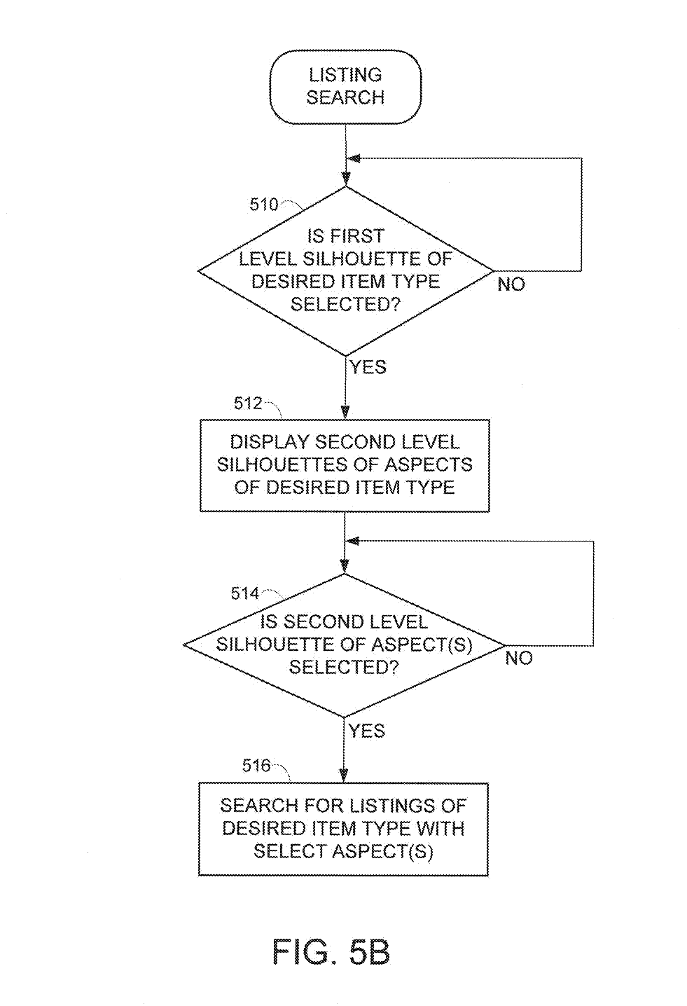

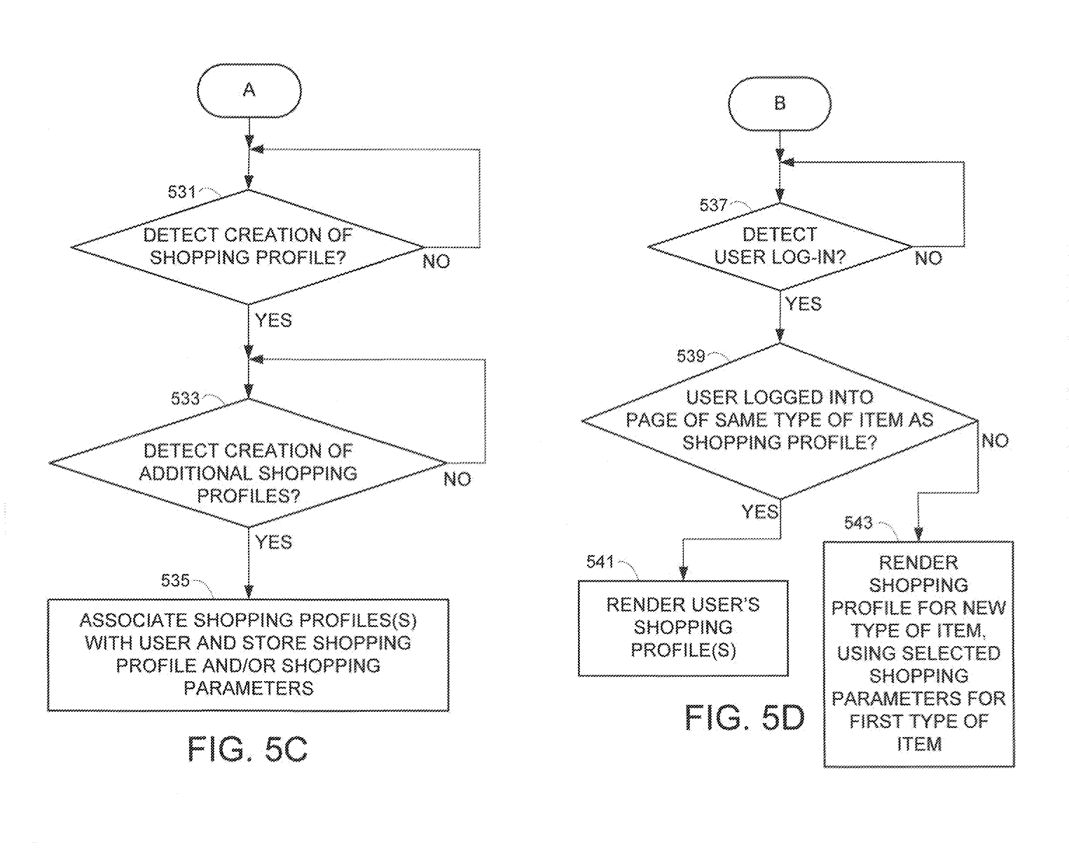

Turning to FIG. 5, if the user selects the “Dresses” silhouette in FIG. 4, the “Dresses” silhouette slides to the left as at 501 showing, or visually uncovering, multiple silhouettes of the various elements of dresses, such as style or length, sleeve, and the like. This is essentially a set of subcategory silhouettes for the primary silhouette “Dresses.” Selecting a particular length and sleeve type will allow one to search by that sleeve type and length of dress. In addition, there is the ability to refine one's search by size of the item desired, concurrently with length and sleeve types, as discussed below. While it is well known to those of ordinary skill in the art how to implement the above description of multilevel silhouettes, the following is included as a matter of additional teaching. Referring to FIG. 5A, when a user is performing a listing search, the system, as seen at 510, checks to see whether a first level silhouette of a desired type of item, such as the “Dress” icon of FIG. 5, has been selected. If the selection is made, then at 512, the system provides signals to display a second level of silhouettes of aspects of item of the selected type. Then as at 514, the system checks to see whether one of the second level silhouettes representing aspects has been selected. If it has been selected, then, as at 516, the system searches, such as by querying a database, for listings of the selected desired type of item having the selected aspect. The display of the second level of silhouettes can be done, for example, by the system providing a signal to “slide” or move the selected primary icon of FIG. 4 to one side of the rendering at FIG. 5, while concurrently displaying the second level of silhouettes seen in FIG. 5 in order to give the appearance to the user of the selected icon sliding over to uncover the second level of silhouettes.

Below the “Create New Profile” box 521 is seen a size map in tile format, comprising the various sizes, and equating numerical sizes to alpha sizes. While the size map is shown in tile format, it could be rendered in silhouette or in any other icon type format. In the size map one could select, for example, S, 4, 6 and the results set shows dresses of the above length and sleeve type, in sizes 4 and 6, with the alpha designation “Small.” This could be concurrent with searching the aspects discussed above. Alternatively, one can select only size 4 under Small and the above result set would be limited with Small, size 4. This gives the user for whom a size 6 might be a little too large the ability to refine her size. Further, it shows the user the relations between the size in alpha (Small) and the numerical sizes in a visual way. As another example, size mapping can be done by two or more alpha sizes, or by more than one or two numerical sizes. As another example, one might know that the appropriate fit is a small or medium, but not really a size 10. So the user can unselect 10 under Medium, leaving 8 under Medium, and also select Small 4, 6. The search results could be all items in 4 or 6, with the alpha size Small appended, and all items in 8, with alpha size Medium appended. Alternatively if a user isn't sure what sizes are within the Medium category, the size map illustrates this visually.

The tile aspect is not limited to the size map. It can also be used in search results in the result set. One example might be for search results, using a tile treatment for various groupings of data, for example, stores or boutiques that handle specific items in the search. Another example might to tile brands, or to tile profiles on a search page. Grouping together related items by tile formatting, or grouping together related data by tile formatting, is an improvement over just putting one big block data on the page.

Continuing with providing the user with a combination of item aspects to search on, FIG. 5 illustrates a left navigation pane that allows the user to search by “Brand;” “Price;” “Condition” of the item offered for sale; Format; and Seller type, identified as shown in the illustration. Each of these elements can be selected and a search could search for items with the selected aspects, concurrently with the other aspects discussed above.

in some systems, when a search in a particular size results in no items found, the system will tell the user there are no items in that size. This can give the user a bad experience. Rather than tell the user there are no items in that size, the page can merely gray out the items on the results set, giving essentially the same information but also having the ability to alleviate or lessen a had user experience.

Size also varies by manufacturer. A Burberry size 4 may be equivalent to a J. Crew size 2. Some customers shop by brand and size. For example, people who are shopping at Burberry are not necessarily the same people shopping at Gap but they may know what size they wear in Gap versus what size they wear at Burberry. For example, Burberry size Small may equate to a 4 in Burberry, where a Gap size small might equate to a size 4 in Gap. White the two are very similar; it may be that just the waist measurements are slightly different, but most of the customers know what sizes fit them by brand. Thus size mapping can be very useful for searching by Brand in addition to other search aspects.

Size mapping can be accomplished, for example, by on online sales organization mining historical sales data. That is, data on what people tend to buy could be mined by computer. Alternatively, this can be done manually. For example, searching people who buy one brand and size and who also buy another brand and size is a relatively simple search algorithm. Other algorithms can also be developed. The results can be aggregated or organized statistically and stored in a search database for presentation to the user as a size map.

Another example of search is single searching on Brand, or multi selecting Brands for search, according to the user's preference. This can be done in at least three ways. One is to scroll down under Brand in the vertical navigation pane of FIG. 5 and select the desired brand(s). If the user multiselects and chooses more than one brand, those brands will concurrently be searched using a search database including the brand data, with the other search aspects discussed above and the results set could show items in the brands, sizes, and types as discussed above. In other words, the system will then pull in images of items of all the brands available for that style, sleeve, and size.

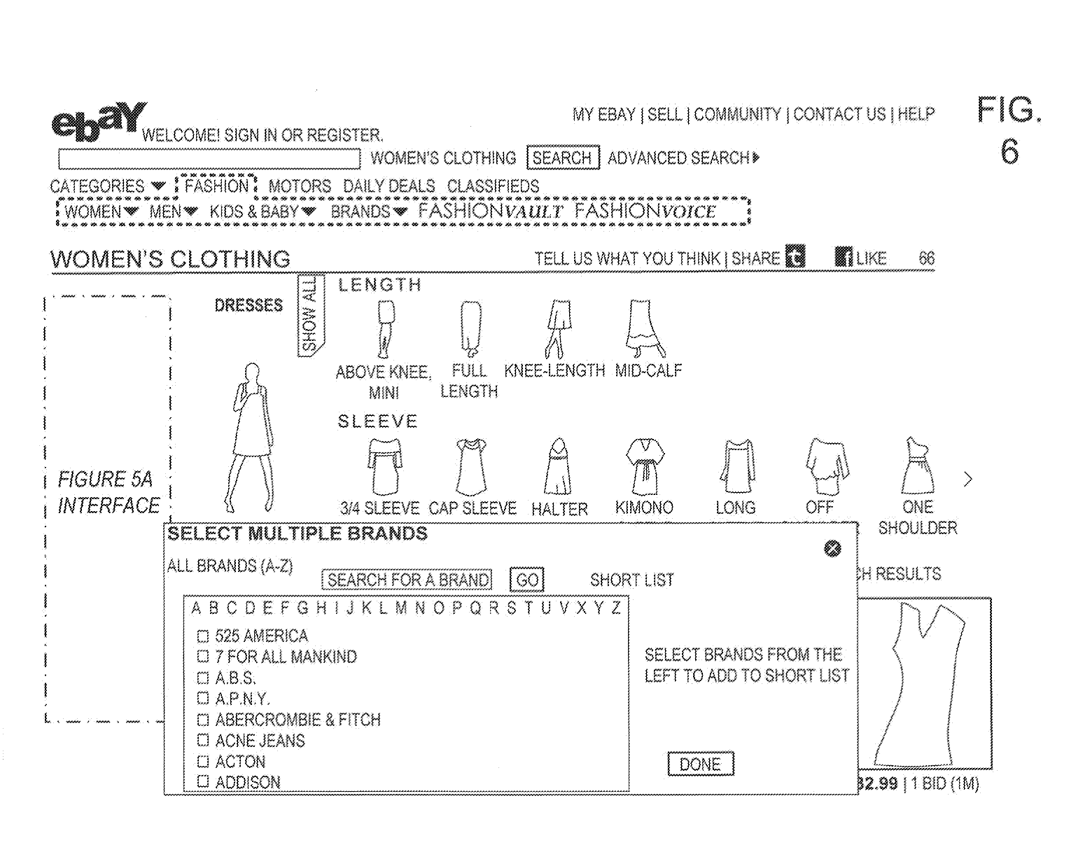

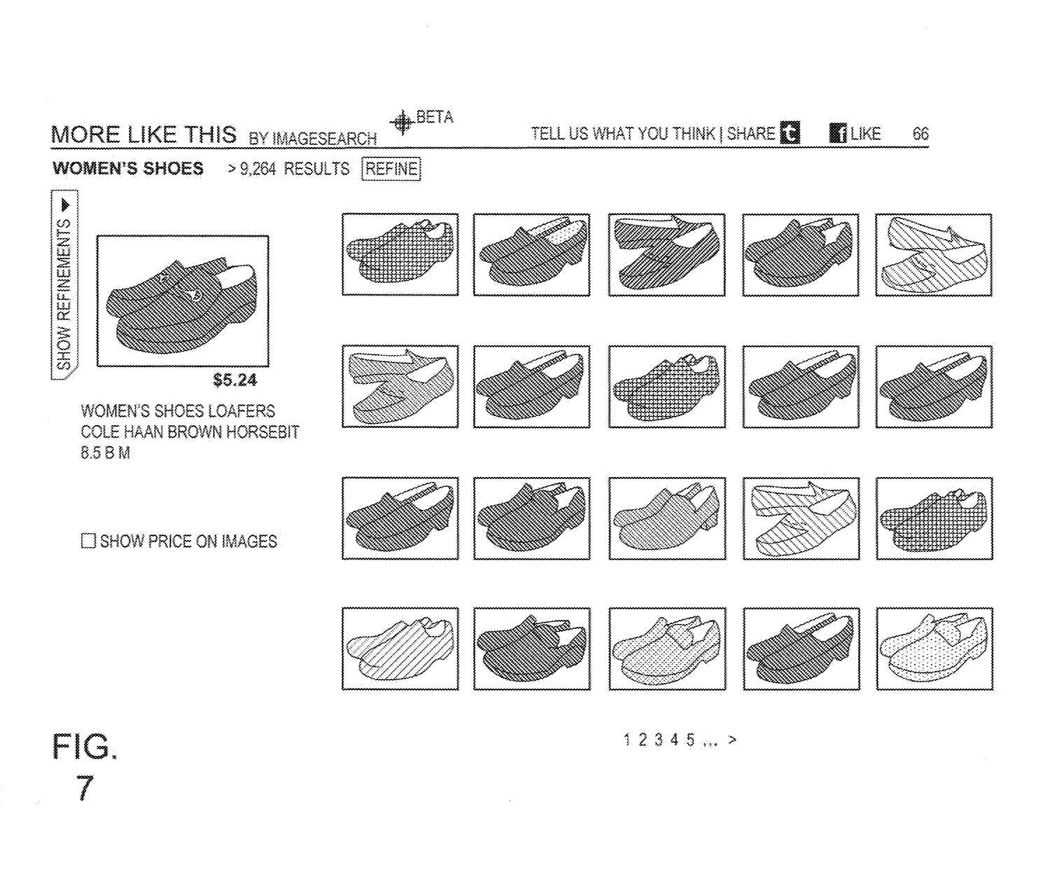

Another way is the click on the “Choose More Brands” text shown in FIG. 5. When “Choose More Brands” is clicked on in FIG. 5, a layer such as shown in FIG. 6 can open and the multiple brands can be available to be selected. Alternatively, a picture of a brand and product can be displayed as at the left of FIG. 7 using known image matching technology that matches a word to a picture, and then using image similarity matching technology that matches that picture with pictures in other brands. This can result in the additional (more) brands at the right of FIG. 7.

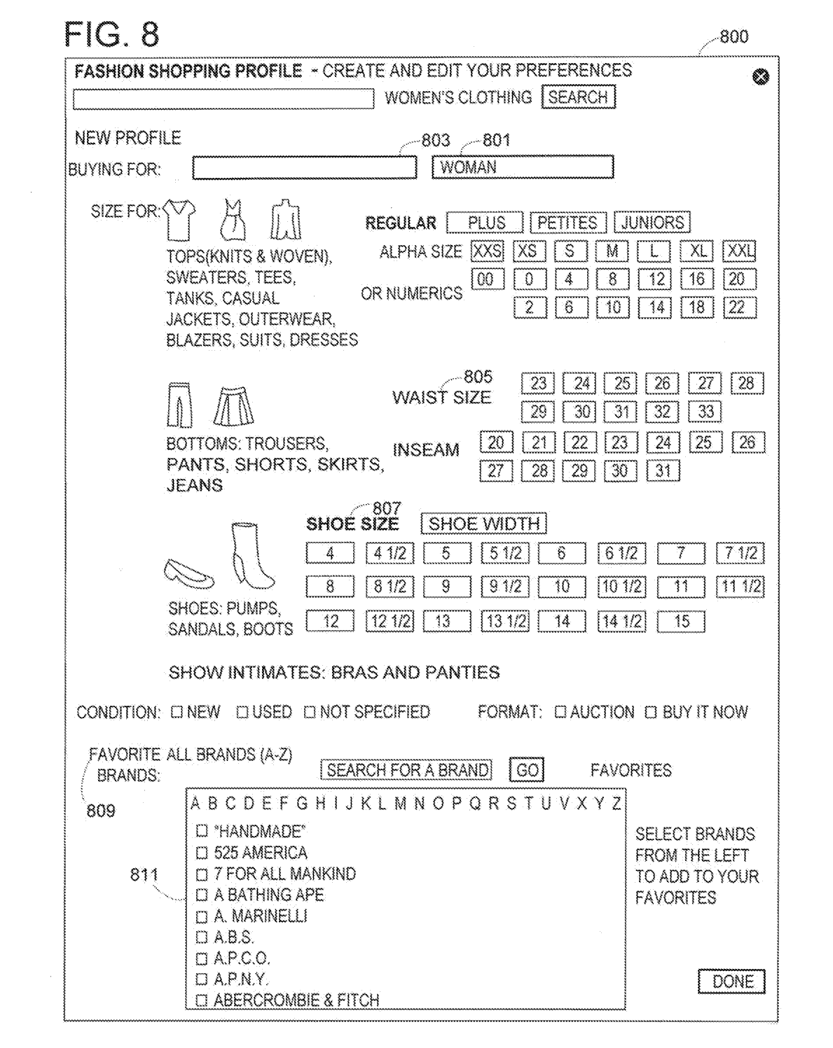

In yet another example, a populating typing implementation can be used as in FIG. 8 by selecting “Short List” and beginning typing in “BCBG,” that the user can check and select. If the user begins typing “Tahari” that populates as well. Alternatively, one can type just T, and select T, and the user will be shown everything that is available in brands beginning with T.

Further, one can click on a brand like Theory, and there would be a database correlating Theory with related brands such as Tahari, and BCBG. The latter two brands can be displayed as alternates to, or along with, BCBG. One can also create a list of selected or favorite brands, sometimes called a “shortlist.” This can be done by clicking Shortlist in the layer of FIG. 6, as an example, and entering or selecting the desired brands in the resulting window. One can search on all the brands in the shortlist, or can deselect some of them if the user just wants to see what's available in one or a few of the brands.

Referring to FIG. 5A, “Condition” and “Format” selections presented in the UI may be used to refine down the result set of items presented in response to a user's search query by indicating the condition of the item and the type of sale it is offered under. If the user mouses over any item in the result set, that item will appear with, for example, title, price information and “More Like This” visual control, which can link to an image search page that would allow a user to find more brands like the one searched or viewed, in addition to the type, sleeve length and size as discussed.

In one embodiment, the system can also implement a “Create New Profile” function in order to permit a user to create one or more shopping profiles. When a user clicks on Create New Profile 521 in FIG. 5, the system may open up display space such as the window 800 seen in FIG. 8. If the UI shown in FIG. 8 is presented to a user as a result of activating a control from a web page displaying women's fashion items, a text box 801 may be prefilled with the value “Women.” In the present example of FIG. 5, the user, activating a control from a web page displaying women's fashions, has selected Dresses as a first type of item, and is creating a shopping profile for the listings of dresses in the context of the on-fine trading system. If the user were activating a control from a web page displaying men's fashions, the system defaults to Men. Then the user can enter a name for a shopping profile for current or subsequent use. The user may give the shopping profile a name, as at 803. For example, the user could name a shopping profile Diana's Every Day Brands, indicating a class of items for shopping for every day occasions, and can enter such selected shopping parameters as waist size shoe size, and favorite brands, which can then be saved. Alternatively, the entire shopping profile can be saved. There could be specified places 805, 807, 809, in the shopping for waist size, shoe size, and favorite brands, respectively. In subsequent log-in the user submits a query to the web page and the query is enhanced by the system presenting the shopping profile (or shopping profiles) without having to go back and re-refine the aspects in the search once the shopping profile is completed. That is, the user does not have to go back and add the shopping parameters of the shopping profile on each log-in as more fully described below.

The user can be given the option of creating a number of shopping profiles, for different types of items, such as dresses as a first type of item, and pants as a second type of item, and for different classes of items, such as lesser expensive, sometimes called “lower end” branded items and more expensive items, sometimes called “high end” branded items. For example, the user can create and name a second shopping profile, for example, Diana's High-End Brands. This could be a second shopping profile for a second class of items, for example, that lists brands for items that are more expensive than the brands of the items in Diana's Every Day Brands shopping profile. The two shopping (profiles can be used, one for every day shopping, and the other for special purchase shopping, at a future date without having to re-refine the aspects of the items searched. One can even create a shopping profile for another person such as a spouse or guest for similar use.

One use of the shopping profile is that on subsequent log-in's the user's shopping profile will be presented to the user. For example the user can be presented with a dropdown of each of her or his different shopping profiles and the user can choose which one is desired at the time. But instead of going through all the refinement processes discussed above, the user easily switches to Diana's Every Day Brands, in our example, and the shopper profile refines down. That is, the entire shopping profile could be refined down, saving significant time and improving the shopping experience.

Further, the shopping profile can be implemented such that once you select, via a user interface provided by an on-line trading system, a type of item, even a different type of item, for example, Blazers or Jackets instead of Dresses, which is the type of item in the current example, the shopping profile will hold all stored refinements and preselect those refinements in a shopping profile for the category Blazers and Jackets, so it becomes easy for the user to look at several different categories at once. This feature can be a great help in minimizing what has come to be known as “buyer fatigue.” As a further example, the user goes to the shopping profile and selects pants, selects her sizes, and selects her brands. The user can then go to Dresses, reselect her brands, and reselect her sizes, in what is an easy way to select a search.

A further use of the shopper's profile is as an aid in sending targeted emails. The data in the shopping profile can be used to target promotions such as sales. For example, the data can be mined and determine that the user's favorite brand is BCBG. If there is a promotion for that brand, the user can be sent a targeted email. Further, if the data shows the user's favorite brand is BCBG and there is a Tahari promotion, which is a related brand to the user's favorite brand, BCBG, the system can send the user a targeted email based on the promotion of the related brand.

Yet another way the shopper profile can be used is to provide the online sales organization information relating to what its inventory needs are. For example, if there are a lot of users indicating certain favorite brands and other information in the shopping profile, this information indicates what pockets of inventory the online sales organization may be shallow in, what users are looking for, and what the online organization needs to move, such, for example, as by promotion. The online sales organization can then use the information in the shopping profile for these purposes.

While it is apparent to one of ordinary skill in the art how to implement the above shopping profile embodiment, the following is provided as additional teaching. FIGS. 5C and 5D illustrate flow charts for a method for creating shopping profiles, in accordance with an example embodiment. The method may be performed by processing logic that may comprise hardware (e.g., dedicated logic, programmable logic, microcode, etc.), software (such as run on a general purpose computer system or a dedicated machine), or a combination of both. The processing logic, according to example embodiments, may reside in any of the modules shown in FIG. 1A. Referring to FIG. 5C, the system at 531 checks to determine whether a user has created a shopping profile. If the system detects a creation of a shopping profile it takes the Yes path to decision point 533. If not, it continues checking for an appropriate time. At 533 the system checks for the detection of additional shopping profiles. If the creation of additional shopping profiles are detected, up to the maximum number of shopping profiles, as the system may be designed, the system 535 associates the shopping profiles with the user and stores the shopping profile. Alternatively, the system may store only the selection shopping parameters of the shopping profile. If, on the other hand, no additional shopping profiles are detected, the system may take the No path and continue check, for at 533 for an appropriate period of time before performing the store step at 535.

As discussed above, the system checks to detect a user log-in, for example, a subsequent log-in of the user, as at 537 of FIG. 5D. If a log-in is detected the decision takes the Yes path and proceeds to decision point 539 where the system checks to determine whether the user is logged in to a page offering for sale the same type of item for which the shopping profile was created. It the user is so logged-in, the system takes the Yes path to function 541 where the system provides the appropriate signal to render the user's shopping profile at the client machine for the user to use in shopping. If the user is logged into a page where a different type of product than the one for which the shopping profile was created (as an example, the users logs in to blazers, and the shopping profile has been created for Dresses), as at the No path of 539, the system then proceeds to step 543 at which the system provides the appropriate signal to render at the user's client machine a shopping profile for the new type of item. This can be done by propagating (or refining) the shopping profile for blazers with the appropriate selected shopping parameters from the already created and stored shopping profile of the user. The user will not have to re-refine the shopping profile from the beginning for the new type of item and thus a certain amount of “Buyer Fatigue” can be forestalled.

### Hardware Operation

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).).

### Example Computer System

FIG. 8 is a block diagram of a machine in the form of a mobile device within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environments, or as a peer machine in peer-to-peer (or distributed) network environments. The machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device (e.g., drive unit 1516), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software) 1523 embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The terms “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via, the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

### APPENDIX

A Mouseover or hover box refers to a GUI event that is raised when the user moves or “hovers” the cursor over a particular area of the GUI. The technique is particularly common in web browsers where the URL of a hyperlink can be viewed in the status bar. Site designers can easily define their own mouseover events using Javascript^{[1]} and Cascading Style Sheets.^{[2]} In case of multiple layers the mouseover event is triggered by the uppermost layer.

Mouseover events are not limited to web design and are commonly used in modern GUI programming. Their existence might not even be known to the user as the events can be used to call any function and might affect only the internal workings of the program.

### Tooltip

A special usage of mouseover event is a tooltip showing a short description of the GUI object under the cursor. The tooltip generally appears only after the mouse is held over the object for a certain amount of time.

### EXAMPLES

<—Direct usage not recommended does not conform with web standards—>
<img id=“myImage” src=“/images/myImage.jpg” on MouseOver=“alert(‘your message’);”>
//javascript without any framework
var myImg=document.getElementById(‘myImage’);
function myMessage( ){

alert(‘your message’);

}
if(myImg.addEventListener){//addEventListener is the standard method to add events to objects

myImg.addEventListener(‘mouseover’, myMessage, false);

}
else if(myImg.attachEvent) {//for Internet Explorer

myImg.attachEvent(‘onmouseover’, myMessage);

}
else {//for other browsers

myImg.onmouseover=myMessage;

}
//jQuery example|degrades well if javascript is disabled in client browser
$(“img”).mouseover(function( ){

alert(‘your message’);});

What is claimed is:

1. A computer implemented method in an electronic system, the method comprising:
using a computer processor, detecting the creation by a user at a UI a client machine of one or more shopping profiles for a first type of item, the shopping profile including selected shopping parameters;
associating the at least one shopping profile with the user and storing at least one of the group consisting of: the at least one shopping profile and at least some of the selected shopping parameters; and
responsive to detecting a log-in by the user, providing a signal for rendering at least one of the at least one shopping profile for the user at the client machine.

2. The method of claim 1, wherein the signal is for rendering a plurality of shopping profiles that are selectable by the user.

3. The method of claim 2, wherein the plurality of shopping profiles include a first shopping profile for a first class of brands and a second shopping profile for a second class of brands.

4. The method of claim 3 wherein one of the two shopping profiles is for high-end brands and the other of the two shopping profiles is for lower-end brand.

5. The method of claim 1, the method further comprising detecting the selection by the user of a second type of item and, responsive to detecting the selection of the second type of item, providing a signal for rendering a shopping profile for the second type of item, at least some of the selected shopping parameters of the shopping profile for the first type of item provided in the shopping profile for the second type of item.

6. The method of claim wherein the shopping profile is created for a type of item illustrated on the web page rendered for the user when the user creates the shopping profile.

7. The method of claim 1, wherein shopping parameters on the shopping profile are mined and used for sending the user an electronic communication addressing a promotion of possible interest to the user.

8. The method of claim 7, wherein the selected shopping parameters include favorite brands, and the promotion of possible interest is a sale of a favorite brand from the favorite brands.

9. The method of claim 7, wherein the selected shopping parameters include favorite brands, the method further including associating the favorite brands with brands related to the favorite brands, detecting a promotion of a brand related to the favorite brand and, responsive to detecting a promotion, sending an electronic communication to the user addressing the promotion.

10. The method of claim 1, wherein shopping parameters from one or more shopping profiles of a plurality of users is mined, and the mined data is used to order inventory.

11. The method of claim 10 wherein the selected shopping parameters include respective identifiers of favorite brands and the inventory is products of the favorite brands.

12. The method of claim 1 wherein data from shopping profiles of a plurality of users is mined to determine products to be targeted by the system for promotion.

13. A non-transitory computer-readable medium having embedded therein a set of instructions which, when executed by one or more processors of a computer, causes the computer to execute the following operations:
detecting the creation by a user at a UI at a client machine of one or more shopping profiles for a first type of item, the shopping profile including selected shopping parameters;
associating the at least one shopping profile with the user and storing at least one of the group consisting of: the at least one shopping profile and at least some of the selected shopping parameters; and
responsive to detecting a log-in by the user, providing a signal for rendering at least one of the at least one shopping profile for the user at the client machine.

14. The computer-readable medium of claim 13, wherein the user creates a plurality of shopping profiles.

15. The computer-readable medium of claim 14, wherein the signal is for rendering a plurality of shopping profiles that are selectable by the use.

16. The computer-readable medium of claim 1, wherein the plurality of shopping profiles include two shopping profiles, each for a different class of brands.

17. The computer-readable medium of claim 16, wherein one of the two shopping profiles is for high end brands and the other of the two shopping profiles is for lower end brands.

18. The computer-readable medium of claim 13, the operations further comprising detecting the selection by the user of a second type of item and, responsive to detecting the selection of the second type of item, providing a signal for rendering a shopping profile for the second type of item, at least some of the selected shopping parameters of the shopping profile for the first type of item being entered on the shopping profile for the second type of item.

19. The computer-readable medium of claim 13 wherein the shopping profile is created for the type of item illustrated on the web page rendered for the user when the user creates the shopping profile.

20. The computer-readable medium of claim 14 wherein shopping parameters on the shopping profile are mined and used for sending the user an electronic communication addressing a promotion of possible interest to the user.

21. The computer-readable medium of claim 20 wherein the selected shopping parameters include favorite brands, and the promotion of possible interest is a sale of a favorite brand.

22. The computer-readable medium of claim 20 wherein the selected shopping parameters include favorite brands, the method further including associating the favorite brands with brands related to the favorite brands, detecting a promotion of a brand related to the favorite brand and, responsive to detecting a promotion, sending an electronic communication to the user addressing the promotion.

23. The computer-readable medium of claim 13 wherein shopping profiles of a plurality of users are mined for data, and the mined data is used to order inventory.

24. The computer-readable medium of claim 23 wherein the selected shopping parameters include favorite brands and the inventory is products of favorite brands.

25. The computer-readable medium of claim 14 wherein shopping profiles of a plurality of users are mined to determine products to be targeted for promotion by the system.

26. A system comprising:
one or more computer processors and storage configured to store and execute:
a receiver module for receiving signals from a client machine;
an analysis module responsive to the signals for detecting the creation by a user at a client machine of at least one shopping profile for a first type of item, the shopping profile including selected shopping parameters, the analysis module including a detector, an associating module, a storing module and a rendering signal module; and
the associating module of the analysis module responsive to the detector module detecting the creation of at least one shopping profile, for associating the at least one shopping profile with the user;
the storing module storing at least one of the group consisting of: the at least one shopping profile and at least some of the selected shopping parameters;
the detector of the analysis module further responsive to signals from the receiver module for detecting a log-in by the user; and
responsive to the detector detecting a login, the rendering signal module providing a signal for rendering at least one of the at least one shopping profile for the user at the client machine.
